(19) United States
(12) Patent Application Publication
(10) Pub. No.: US 2016/0109075 A1
(43) Pub. Date: Apr. 21, 2016

(54) Hand Held Illuminated Signaling Device for Prospective Riders

(71) Applicants: Devin Heck, New York, NY (US); Christa Orsino, Maybrook, NY (US)

(72) Inventors: Devin Heck, New York, NY (US); Christa Orsino, Maybrook, NY (US)

(21) Appl. No.: 14/883,871

(22) Filed: Oct. 15, 2015

Related U.S. Application Data
(60) Provisional application No. 62/064,927, filed on Oct. 16, 2014.

(51) Int. Cl. F21L 4/00; G08B 7/06; F21V 33/00; F21V 23/04; F21V 31/00

(52) U.S. Cl. CPC F21L 4/00; F21V 23/0414; F21V 31/00; F21V 33/0076; G08B 7/06; F21L 2001/00

(57) ABSTRACT

A hand held, battery operated, illuminated signaling device used by individuals to hail taxicabs. It is a user friendly, ergonomically designed signaling device that is convenient to carry and adaptable to being stored in pockets, purses, and the like. One embodiment of the illuminating signaling device, comprises a body, a printed circuit board, a light source array, a bezel having at least one of a perimeter opening and at least one of a top opening, wherein the perimeter opening and the top opening are situated to receive an individual light source of the light source array, a retainer adapted to support the light source array and wherein the bezel is coupled to the light source array and wherein the light source array is mounted on the retainer.

### PRIORITY CLAIM/INCORPORATION BY REFERENCE

This application claims priority to U.S. Provisional Application 62/064,927 entitled “Hand Held Illuminated Signaling Device For Prospective Riders and Professional Drivers” filed on Oct. 16, 2014, the entirety of which is incorporated herein by reference.

### FIELD

This device pertains to the field of illuminating signaling devices and more particularly to a hand held, battery operated illuminating signaling device used by individuals to hail taxicabs.

### BACKGROUND

In most major cities, a prospective rider signals a taxicab driver by extending his or her arm in an upward position. Often, due to crowded walkways, parked cars, bus stop structures, signs and the like, the rider will step off the sidewalk or curb on to the street to increase visibility. This puts the rider at risk for injury from oncoming traffic and does not ensure desired visibility and effectiveness, especially during inclement weather and at night. The disabled and elderly are in positions of even greater reduced visibility due to physical constraints that prevent them from being able to easily segregate themselves from crowds and other obstacles. When doormen signal taxicabs to secure transportation for guests or residents, they too will step off the curb or sidewalk into the path of oncoming traffic often utilizing a startling, high pitched whistle as a means of signaling taxicab drivers, which also creates an unsafe circumstance as well as contributing to environmental noise.

### SUMMARY

One exemplary embodiment of an illuminating signaling device includes a body, a printed circuit board, a light source array, a bezel having at least one of a perimeter opening and at least one of a top opening, wherein the perimeter opening and the top opening are situated to receive an individual light source of the light source array, a retainer adapted to support the light source array; and wherein the bezel is coupled to the light source array and wherein the light source array is mounted on the retainer.

### BRIEF DESCRIPTION OF THE FIGURES

FIG. 1 shows perspective view of an illuminating signaling device according to various exemplary embodiments.

FIG. 2 shows a cross section view of an illuminating signaling device according to various exemplary embodiments.

FIG. 3 shows a top view or an illuminating signaling device according to various exemplary embodiments.

### DETAILED DESCRIPTION

The exemplary embodiment may be further understood with reference to the following description and the appended drawings, wherein like elements are referred to with the same reference numerals.

The exemplary embodiments are directed to a hand held, battery operated, illuminated signaling device used by individuals to hail taxicabs. It is a user friendly, ergonomically designed signaling device that is convenient to carry and adaptable to being stored in pockets, purses, and the like. The device may be water resistant to allow for signaling taxicabs and clients during inclement weather when visibility is often most difficult without compromising the device's function.

An exemplary device comprises a body 101 that is substantially tubular with a circular opening located at the top portion of the body 101 and a closed tip located at the bottom portion of the body 101. The body 101 also has a partially hollow interior that may contain a printed circuit board 201 and button cells 202. The button cell 202 and an LED array 103 are electrically coupled to the printed circuit board 201. The LED array 103 is mounted to a retainer 102 in order for the LED array 103 to be secured at the top portion of the body 101. A bezel 104 with openings situated to receive individual LEDs from within the LED array 103 is coupled to the LED array 103 mounted on the retainer 102. A clear cap 106 is removably coupled to the top portion of the body 101 and is placed over the retainer 102, bezel 104, and LED array 103. The general structure of the device can be made of any conventional material. Plastics are particularly useful for making the device, but portions of the device may also be constructed from metal, glass, composites, etc.

The signaling function of the preferred embodiment of the device occurs when a user pushes a mode switch 105 that is located on the body 101 of the device. By pushing the mode switch 105 that closes a circuit the LED array 103 is activated. When activated the LED array 103 can be set to illuminate with variable frequency speeds and include a mode for steady illumination and flashlight.

One exemplary embodiment of the illuminated signaling device may include a self-defense sprayer. Wherein the self-defense sprayer includes a self-defense spray canister, a self-defense spray button, and a nozzle. Wherein the self-defense spray canister is mounted to the body 101 or contained within the partially hollow interior of the body 101. The self-defense spray canister may hold pepper spray, capsicum spray, or other suitable liquid or gas. The nozzle may be located on the body 101 of the device and is connected to the self-defense spray canister in order to allow the liquid or gas contained within the self-defense to travel to the nozzle. The self-defense spray button may be located on the body 101 of the device and may be coupled to the nozzle. When a user selects the self-defense spray button the liquid or gas contained within the self-defense spray canister travels to the nozzle. The nozzle is positioned away from the user and when the liquid or gas contained in the self-defense spray canister reaches the nozzle it projects in the direction that the nozzle is positioned.

One exemplary embodiment of the illuminated signaling device may include a self-defense alarm. Wherein the self-defense alarm includes a speaker and a self-defense alarm button. The speaker may be mounted to the body 101 device or contained within the partially hollow interior of the body 101. The speaker is electrically coupled to the printed circuit board 201. The self-defense alarm button is located on the body 101 of the device. By pushing the self-defense alarm button that closes a circuit the speaker is activated and an audio signal is produced.

Accordingly, the exemplary hand held, illuminated signaling device of the various embodiments can be used to signal taxicab drivers more safely, effectively and ergonomically than current methods. Furthermore, the foregoing described embodiments allow for adaptability of the device to allow for multiple uses. Although the description of the device contains much specificity, these should not be construed as limiting the scope of the embodiments but as merely providing illustrations of some of several embodiments. For example, the device can be different sizes or other shapes, such as round, square, etc.; the light source can be various colors and tubular in design.

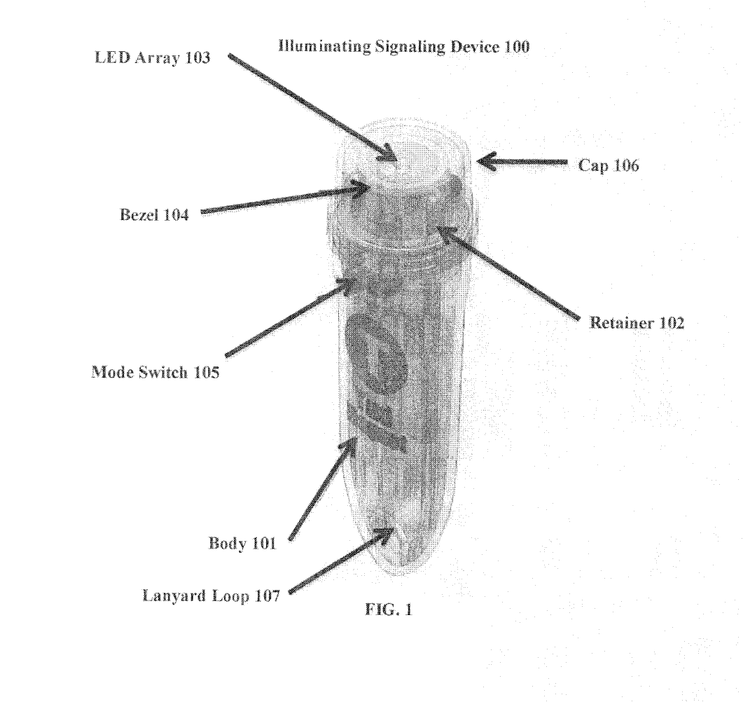

FIG. 1 shows a perspective view of an illuminating signaling device 100 according to an exemplary embodiment. The illuminating signaling device 100 includes a body 101, which is substantially tubular having a circular opening located at the top of the body 101 and a closed rounded tip located at the bottom of the body 101. The body 101 is solid but has a partially hollow interior. The body 101 may have a lanyard loop 107, which is a horizontal pathway located near the closed rounded tip at the bottom of the body 101 shaped to support a piece of lanyard or other suitable material where the piece of lanyard or other suitable material is sized and shaped to support the illuminating signaling device 100 around the wrist of a user or attached to a piece of clothing or article carried by the user (e.g. a purse). The body 101 may be constructed from any suitable plastic material or any other appropriate material. The illuminating signaling device 100 includes a retainer 102, which is shaped to support the bulbs of an LED array 103. The retainer 102 is coupled to the circular opening located at the top of the body 101. The retainer 102 may be constructed from any suitable plastic material or any other appropriate material. The illuminating signaling device 100 includes a bezel 104, which is placed over the retainer 102 supporting the LED array 103 and contains the same number of openings as the number of LEDs within the LED array 103 where the openings are sized to receive an LED. In one exemplary embodiment one opening is located at the top center of the bezel 104 and six openings are spaced evenly along the periphery of the bezel 104. The bezel 104 may be constructed from any suitable reflective plastic material or any other appropriate material. The illuminating signaling device 100 contains a mode switch 105 located on the front face of the body 101 near the circular opening located at the top of the body 101. The mode switch 105, when pressed by a user will activate the illuminating function of at least some of the LEDs within the LED array 103. The mode switch 105 may be a pushbutton switch, a toggle switch, a slide switch, or any other appropriate means for activating the electrical circuit. The illuminating signaling device 100 includes a cap 106, which is coupled to the circular opening at the top of the body 101. The body 101 and the cap 106 may be coupled together via threading or other suitable connecting means. The cap 106 may be constructed from any suitable clear plastic material or any other appropriate material.

FIG. 2 depicts a cross section of an illuminating signaling device 100 according to an exemplary embodiment. The body 101 contains a partially hollow interior shaped to hold at least a printed circuit board 201, button cells 202, the leads for the LEDs, and the mode switch 105. The printed circuit board 201 is coupled to the button cells 202 via a battery connector or any other appropriate means that accomplishes an electrical connection between the printed circuit board 201 and the button cells 202. The printed circuit board 201 is coupled to the mode switch 105 and the LED array 103 by soldered joint, a screw, a nut and bolt, or any other appropriate means of accomplishing an electrical connection between the two. The retainer 102 supports the LED array 103 and has at least one opening which provides a pathway to the partially hollow interior of the body 101 in order to allow the leads for the LEDs of the LED array 103 to pass through the retainer 102 and connect to the printed circuit board 201.

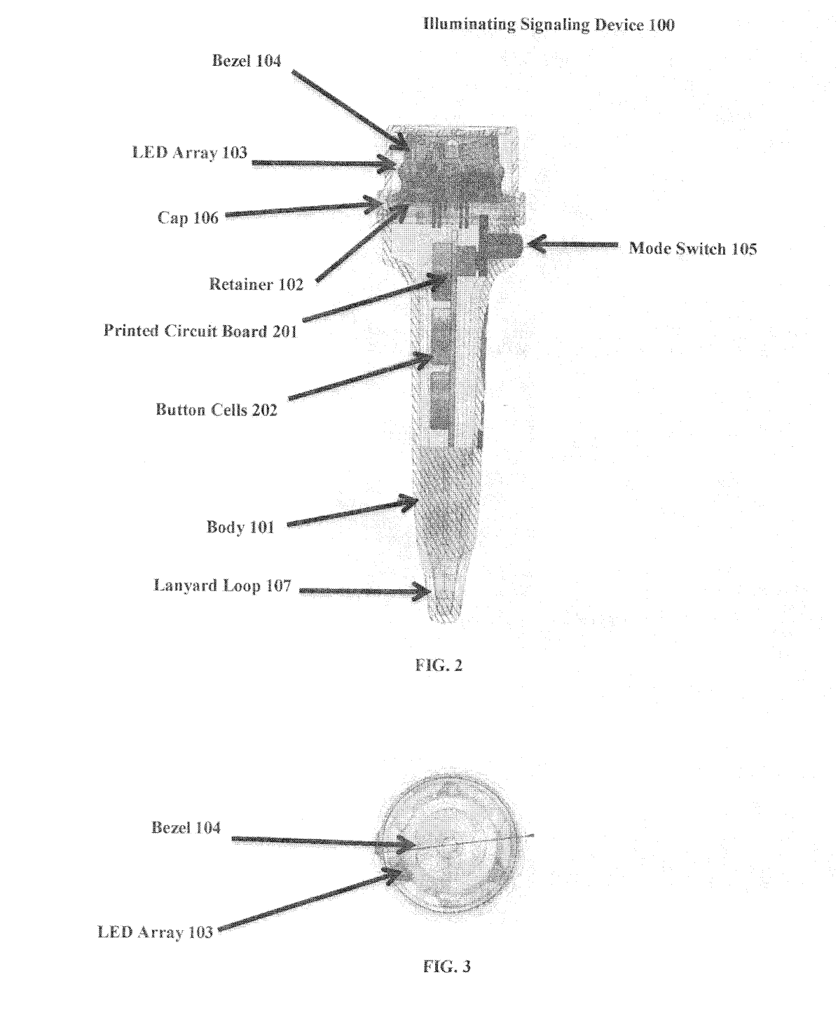

FIG. 3 depicts a top view of an illuminating signaling device 100 according to an exemplary embodiment. The illuminating signaling device 100 contains the LED array 103 but the illuminating signaling device 100 may utilize a different number of LEDs than pictured in FIG. 3 or may instead utilize incandescent light bulbs, fluorescent light bulbs, halogen light bulbs or any other appropriate lighting means. In one exemplary embodiment, the LED array 103 may comprise of seven LEDs. Six LEDs are positioned facing radially outward and may be spread evenly along a circle whose diameter is approximately the size of the diameter of the circular opening located at the top of the body 101. One LED is positioned vertically and approximately perpendicular to the other six LEDs. The retainer 102 is shaped to hold the LEDs in the positions described above. The bezel 104 is placed over the retainer 102 and LED array 103. The bezel 104 has an opening, located at the top center of the bezel 104, shaped to receive the LED bulb that is positioned vertically and approximately perpendicular to the other six LEDs. The bezel 104 has six openings, spread evenly along the periphery of the bezel 104, shaped to receive the six LED bulbs.

The operation of the exemplary embodiment of the illuminating signaling device 100 will be discussed with reference to FIG. 1. A user holds the illuminating signaling device 100 in their hand and presses the mode switch 105. When the user presses the mode switch 105 a first time the electrical circuit is closed and LEDs located along the periphery of the bezel 104 are activated. When activated the first time, the LEDs along the periphery of the bezel 104 may illuminate in a flashing pattern at a first set frequency. When the user presses the mode switch 105 a second time, the LEDs along the periphery of the bezel 104 may illuminate in a flashing pattern at a second set frequency. When the user presses the mode switch 105 a third time the LEDs along the periphery of the bezel 104 may illuminate at a steady state. When the user presses the mode switch 105 a fourth time the LEDs along the periphery of the bezel 104 are no longer activated and the LED located at the top center of the bezel 104 is activated and may illuminate in a flashing pattern or in a steady state in order to function as a flashlight. Each LED within the LED array 103 may illuminate at the same color, each LED may illuminate at a different color, or the LEDs may be grouped in a combination thereof. Each LED within the LED array 103 may be visible at least one city block away. When the user selects the mode switch 105 a fifth time the electrical circuit is no longer closed and none of the LEDs are activated. Other embodiments of the illuminating signaling device 100 may have more or less illuminating modes. Other embodiments of the illuminating signaling device 100 may include more than one switch where a single switch could be dedicated to powering the device on and off and another switch could be dedicated to toggling between illuminating modes or each illuminating mode could have their own dedicated switch.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

1. An illuminating signaling device, comprising:
a body;
a printed circuit board;
a light source array;
a bezel having at least one of a perimeter opening and at least one of a top opening, wherein the perimeter opening and the top opening are situated to receive an individual light source of the light source array;
a retainer adapted to support the light source array; and
wherein the bezel is coupled to the light source array and wherein the light source array is mounted on the retainer.

2. The illuminating signaling device according to claim 1, wherein the body is substantially tubular having a circular opening at a top portion of the body and a closed tip located at a bottom portion of the body;
wherein the body contains a partially hollow interior situated to receive at least the printed circuit board and an at least one battery.

3. The illuminating signaling device according to claim 1, wherein the retainer adapted to support the light source array is coupled the top portion of the body.

4. The illuminating signaling device according to claim 1, wherein the light source array is powered by the at least one battery.

5. The illuminating signaling device according to claim 2, where the at least one battery is electrically coupled to an at least one layer of the printed circuit board.

6. The illuminating signaling device according to claim 1, wherein the device further comprises:
a mode switch,
wherein pressing the mode switch activates the light source array.

7. The illuminating signaling device according to claim 1, wherein the light source is one of a incandescent light bulb, a fluorescent light bulb, a halogen light bulb and a light emitting diode.

8. The illuminating signaling device according to claim 1, wherein the device further comprises:
a cap,
wherein the cap is coupled to the top portion of the body and is situated over the bezel and light source array.

9. The illuminating signaling device according to claim 8 wherein the cap is one of clear and reflective material.

10. The illuminating signaling device according to claim 8, wherein the cap is permanently coupled to the top portion of the body.

11. The illuminating signaling device according to claim 8, wherein the cap is removably coupled to the top portion of the body.

12. The illuminating signaling device according to claim 1, wherein the device further comprises a lanyard loop adapted to support the illuminating signaling device from the wrist of a user of the device.

13. The illuminating signaling device according to claim 1, wherein the device is water resistant.

14. The illuminating signaling device according to claim 1, wherein the light source array is electrically coupled to the printed circuit board.

15. The illuminating signaling device according to claim 1, further comprising a self-defense sprayer. Wherein the self-defense sprayer comprises:
a self-defense spray canister;
a nozzle; and
a self-defense spray button.

16. The illuminating signaling device according to claim 1, further comprising a self-defense alarm. Wherein the self-defense alarm comprises:
a speaker; and
a self-defense alarm button.

17. The illuminating signaling device according to claim 3, wherein the retainer adapted to support the light source array is shaped to position at least one light source from within the light source array radially outward and along a perimeter of the retainer;
wherein each light source that is positioned along the perimeter of the retainer is spread out evenly along the perimeter of the retainer; and
wherein the retainer adapted to support the light source array is shaped to position at least one light source from within the light source array vertically and approximately perpendicular to the light source that is positioned along the perimeter of the retainer.
